(19) United States
(12) Patent Application Publication
(10) Pub. No.: US 2021/0037429 A1
(43) Pub. Date: Feb. 4, 2021

(54) TECHNIQUES FOR RADIO CELL RESELECTION

(71) Applicant: Apple Inc., Cupertino, CA (US)

(72) Inventors: Gaurav Kothari, Bikaner RJ (IN); Deepak Dash, Khordha (IN)

(21) Appl. No.: 16/965,731

(22) PCT Filed: Jan. 30, 2018
(86) PCT No.: PCT/US2018/015871

§ 371 Date: Jul. 29, 2020

(51) Int. Cl. H04W 36/00; H04W 60/00

(52) U.S. Cl. CPC H04W 36/0022; H04W 60/00; H04W 36/00835

(57) ABSTRACT

This disclosure relates to a user equipment (UE) circuitry comprising a processor, wherein the processor is configured to: receive a message indicating a redirection from a first radio network to a second radio network while the UE is registered in the first radio network under a first location area code (LAC); initiate a cell search for radio cells of the second radio network, wherein a specific LAC is assigned to at least one radio cell of the second radio network; and connect to a first radio cell found by the cell search based on a comparison of a LAC of the first radio cell and the first LAC under which the UE is registered in the first radio network.

### FIELD

The disclosure relates to techniques for radio cell reselection, in particular a user equipment circuitry initiating a cell search when receiving a redirection message and a corresponding method. The disclosure further relates to Mobile Termination (MT) Circuit Switch Fallback (CSFB) call handling in case of cell edge scenarios.

### BACKGROUND

In current real-time mobile communication networks, e.g. according to the 3GPP standard, scenarios are observed where a user equipment (UE) or mobile device is registered in a first Radio Access Technology (RAT) network, such as e.g. LTE, under tracking area code TAC1 and is registered in a second RAT network, such as e.g. UMTS or GSM, under location area code LAC1 and it received a mobile termination (MT) Circuit Switch FallBack (CSFB) call and hence is redirected to UMTS or GSM at a specific UTRA absolute radio frequency channel number, e.g. UARFCN1. The UE finds a cell on selected channel number UARFCN1, but the cell is in a different LAC, e.g. LAC2 as the UE was in a border area of two LACs, namely LAC1 and LAC2, leading to a Location Area Update triggered by UE instead of a Paging response immediately after camping on the second RAT network (UMTS).

After successfully performing location area update (LAU), the UE waits for the MT call, but the network does not forward any MT Call to UE due to certain reasons like the following: 1) MSC changed and it is not able to contact the old MSC; 2) Failure to forward call context from old MSC to new MSC; 3) LAU took more time and call was already released.

In the present disclosure techniques are presented to solve the problems described above and to allow the UE receiving MT calls from the network, in particular in cell edge scenarios.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description.

FIG. 1a is a schematic diagram illustrating a circuit switch fallback (CSFB) scenario 100a in a communication system including an LTE network 111 and a UMTS/GSM network 121.

FIG. 1b is a schematic diagram illustrating a return from CSFB scenario 100b in the communication system of FIG. 1a.

FIG. 2 is a schematic diagram illustrating a CSFB scenario in a communication system 200 including a first Radio Access Technology (RAT) network and a second RAT network according to an embodiment of the disclosure.

FIG. 3 is a message sequence chart 300 for a CSFB scenario in the communication system 200 of FIG. 2 for a failed mobile terminating (MT) call.

FIG. 4 is a message sequence chart 400 for a CSFB scenario in the communication system 200 of FIG. 2 for a successful mobile terminating (MT) call according to an embodiment of the disclosure.

FIG. 5 is a block diagram 500 of a user equipment (UE) circuitry 500 according to an embodiment of the disclosure.

FIG. 6 is a schematic diagram of a method 600 for redirection from a first radio network to a second radio network according to an embodiment of the disclosure.

### DETAILED DESCRIPTION

In the following detailed description, reference is made to the accompanying drawings, which form a part thereof, and in which is shown by way of illustration specific aspects in which the disclosure may be practiced. It is understood that other aspects may be utilized and structural or logical changes may be made without departing from the scope of the present disclosure. The following detailed description, therefore, is not to be taken in a limiting sense, and the scope of the present disclosure is defined by the appended claims.

The following terms, abbreviations and notations are used herein:
CSFB: Circuit Switch FallBack
RAT: radio access technology,
LAC: Location Area Code
TAC: Tracking Area Code
LAU: Location Area Update
UARFCN UTRA Absolute Radio Frequency Channel Number
UMTS: Universal Mobile Telecommunication System
GSM: Global System for Mobile Communications
UTRA: UMTS Terrestrial Radio Access
EUTRA: evolved UMTS Terrestrial Radio Access
LTE: Long Term Evolution
UE: User Equipment, mobile device, cellular handset
CS: circuit switched
PS: packet switched
2G/3G/4G: 2^{nd}/3^{rd}/4th Generation
MSC: Mobile Switching Center
PLMN: Public Land Mobile Network
MME: Mobility Management Entity
NodeB,
eNodeB: Radio cell, radio access, base station
RRC: Radio Resource Control
NE: Network Element

It is understood that comments made in connection with a described method may also hold true for a corresponding device configured to perform the method and vice versa. For example, if a specific method step is described, a corresponding device may include a unit to perform the described method step, even if such a unit is not explicitly described or illustrated in the figures. Further, it is understood that the features of the various exemplary aspects described herein may be combined with each other, unless specifically noted otherwise.

The techniques described herein may be implemented in wireless communication networks, in particular communication networks based on mobile communication standards such as LTE, in particular LTE-A and/or OFDM and successor standards such as 5G. The methods are also applicable for high speed communication standards from the 802.11 family according to the WiFi alliance, e.g. 802.11ad and successor standards. The methods and devices described below may be implemented in electronic devices such as cellular handsets, mobile or wireless devices (or mobile stations or User Equipment (UE)). The described devices may include integrated circuits and/or passives and may be manufactured according to various technologies. For example, the circuits may be designed as logic integrated circuits, analog integrated circuits, mixed signal integrated circuits, memory circuits and/or integrated passives.

In the following, embodiments are described with reference to the drawings, wherein like reference numerals are generally utilized to refer to like elements throughout. In the following description, for purposes of explanation, numerous specific details are set forth in order to provide a thorough understanding of one or more aspects of embodiments. However, it may be evident to a person skilled in the art that one or more aspects of the embodiments may be practiced with a lesser degree of these specific details. The following description is therefore not to be taken in a limiting sense.

The various aspects summarized may be embodied in various forms. The following description shows by way of illustration various combinations and configurations in which the aspects may be practiced. It is understood that the described aspects and/or embodiments are merely examples, and that other aspects and/or embodiments may be utilized and structural and functional modifications may be made without departing from the scope of the present disclosure.

An embodiment of a basic idea of the present disclosure is to introduce a mechanism in which a UE can detect that there is a change of location area code (LAC) when it was redirected for CSFB calls and moved to a different LAC and thus has to perform location area update (LAU), but the network does not support forwarding call context to the new mobile switching center (MSC) or the old MSC is not reachable leading to call failures in both cases.

In the present disclosure an exemplary solution is presented to the above described problem in edge cases, when the UE is at the boundary of tracking areas/location areas. When applying the presented exemplary solution, any mobile terminating CSFB calls received in LTE can be successfully received by the UE. The exemplary solution presents a UE optimization which can handle such use cases and thus provide good user experience.

In current networks there are no appropriate solutions available in order to handle this scenario where the network failed to forward MT call context, i.e. the UE can do nothing to retrieve back calls in such cases. By applying the concept described in the present disclosure, the UE can detect the abnormality in the network and can search for a cell/MSC to camp on which can forward the MT calls successfully. This kind of issue already exists in major telecommunication provider networks and can happen in networks worldwide as described above.

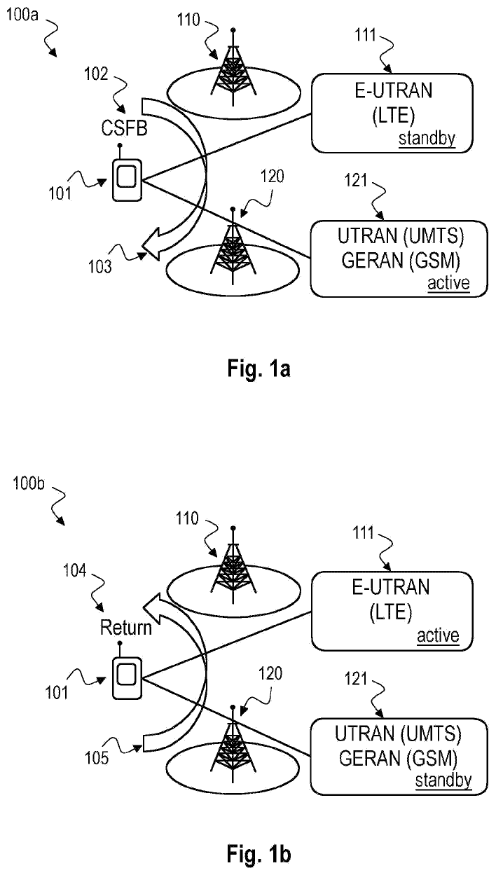

FIG. 1a is a schematic diagram illustrating a circuit switch fallback (CSFB) scenario 100a in a communication system including an LTE network 111 and a UMTS/GSM network 121. FIG. 1b illustrates the corresponding return scenario 100b.

LTE (Long Time Evolution) networks 111 were designed for packet based services such as Internet Protocol (IP) traffic. However, a majority part of today's traffic originates from circuit-switch (CS) based services like Voice and SMS (Short Message Service). Therefore, 3GPP agreed to include an intermediate solution for CS based services until IP-based services like Voice over LTE (VoLTE) are completely developed and deployed. Using circuit switch Fallback (CSFB) 102, a UE 101 can switch (as indicated by 103) to GERAN, UTRAN or other 2G/3G systems 121 for voice services. CS fallback services 102 are available in those areas where EUTRAN systems 111 overlap with GERAN, UTRAN or other 2G/3G systems 121.

As shown in FIGS. 1a and 1b, the UE 101 is registered via eNodeB 110 in an E-UTRAN (LTE) network 111 and via NodeB 120 in an UTRAN (UMTS) or GERAN (GSM) network 121. When the UE 101 or mobile phone starts a voice call in E-UTRAN 111, the network moves (see 103) the UE 101 to legacy UMTS (3G) or GSM (2G) network 121. The LTE network 111 is in standby mode and the UMTS/GSM network 121 is in active mode. The UE 101 uses the legacy network 121 to initiate the call and complete the call. When in legacy network (3G/2G) 121, the UE 101 can have PS data sessions. After the call is over, the UE 101 returns (see 104) to the LTE network 111 as shown in FIG. 1b. The LTE network 111 changes to active mode, and the UMTS/GSM changes to standby mode as the UE is moved back (see 105) to LTE network 111.

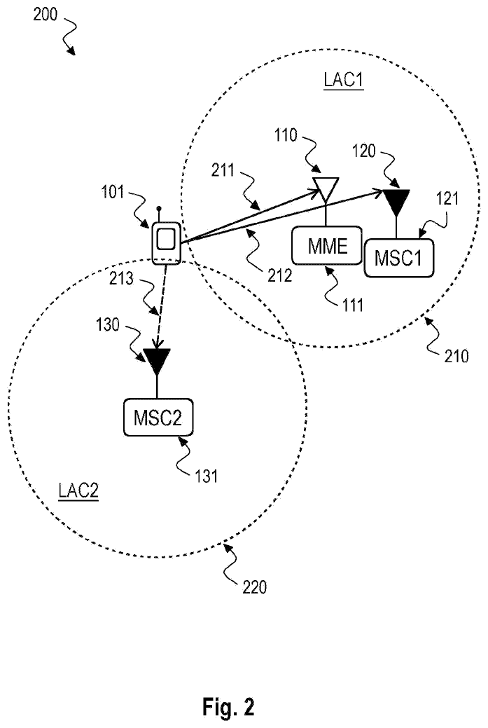

FIG. 2 is a schematic diagram illustrating a CSFB scenario in a communication system 200 including a first Radio Access Technology (RAT) network and a second RAT network according to an embodiment of the disclosure.

In the scenario of FIG. 2, a UE 101 is registered in a first radio network via a first radio cell 110, e.g. eNodeB, and a first network device 111, e.g. mobility management entity (MME) 111. The UE is further registered via radio cell 110 to a second network device 121, e.g. mobile switching center MSCI. A first location area code LAC1 (also referred to as first tracking area code TAC1) is assigned to the first radio cell 110 and the second radio cell 120. LAC1 specifies the area 210 served by the first radio cell 110 and/or the second radio cell 120.

The served area of a cellular radio network is usually divided into location areas. Location areas are comprised of one or several radio cells. Each location area is given a unique number within the network, the Location Area Code (LAC). This code is used as a unique reference for the location of a mobile subscriber. In addition, this code is necessary to address the subscriber in the case of an incoming call. The LAC forms part of the Location Area Identifier (LAI) and is broadcasted on the Broadcast Control Channel (BCCH).

Note that location area code and tracking area code have the same meaning in the present disclosure, i.e. to indicate a specific location in which the radio cell is operating.

When the UE 101 receives a message indicating a redirection from the first RAT network to the second RAT network, e.g. a CSFB message 102 as described above with respect to FIGS. 1a and 1b, the UE 101 moves connection from first RAT network 110, 111 to second RAT network 120, 121. When the UE 101 is in a cell edge scenario, i.e. located at the border of two cell served areas 210, 220 as shown in FIG. 2, the UE 101 may find a better radio cell (e.g. of higher power or better quality) in a cell served area 220 of another (third) radio network that is served by another (third) radio cell 130, e.g. NodeB and another (third) network device 131, e.g. MSC2 than its originally serving radio cell 120 and network device 121. In such case, the UE 101 is redirected to the third radio network 130, 131.

A second location area code LAC2 (also referred to as second tracking area code TAC2) is assigned to the third radio cell 130. LAC2 specifies the area 220 served by the third radio cell 130. Due to the redirection the UE 101 has switched from a first location area code LAC1 to a second location area code LAC2. Now, the second MSC 131 is responsible for serving the UE 101.

The concept described in the present disclosure mainly focuses on finding out if MT CSFB calls are reachable to the UE 101 or not when it is moving to some other LAC which was not registered LAC in LTE, e.g. from LAC1 to LAC2 as shown in FIG. 2. In such cases, if call failure occurs it is highly probable that the network is not able to forward the MT calls to new LAC leading to call failures. Here, the UE 101 can make an adaptive solution, where after not receiving MT calls in different LAC other than the registered LAC in LTE, the UE 101 can keep track of list of {PLMN, LAC} combination and on reaching a certain threshold number of failures in MT call, it can consider that there is some issue with the network interface not able to forward the call from one LAC to another.

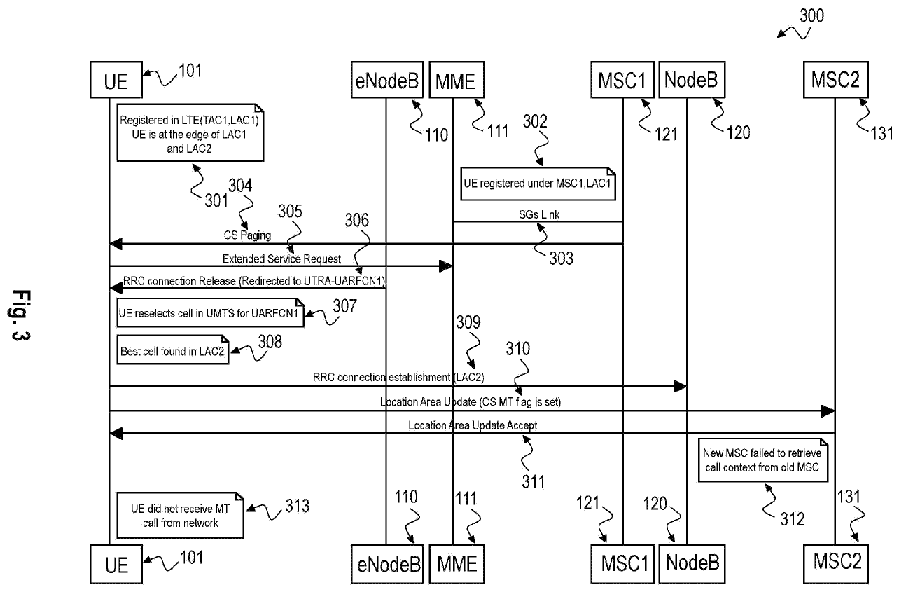

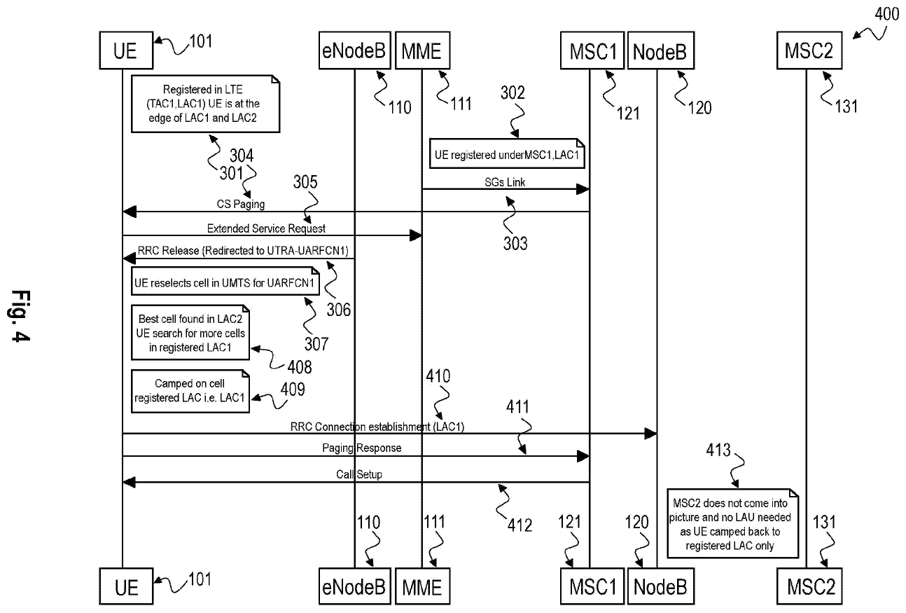

In the following FIGS. 3 and 4, message sequence charts are shown for the scenario that the UE is redirected to a radio cell having a different LAC 220 or that the UE has some intelligence to detect such situation and stay within the same LAC.

FIG. 3 is a message sequence chart 300 for a CSFB scenario in the communication system 200 of FIG. 2 for a failed mobile terminating (MT) call.

The scenario is the following: the UE 101 was registered 301 in LTE—TAC1 (part of TAI list) and LAC1. The UE 101 received CS paging 304 or CS service notification for MT calls, and it got redirected by network to UARFCN1 in UMTS. The UE 101 will try to find the best cell with UARFCN1 and camp on it, but if the UE 101 is in cell/LAC edge, it camped on a cell with UARFCN1, but it was in different LAC i.e. LAC2 other than the registered LAC, i.e. LAC1 in LTE, this leads to Location Area Update 310 to network. After successful LAU 311, the UE 101 failed to receive MT call 313, probably either new MSC 131 failed 312 to fetch call context from old MSC 121.

The following messages and contexts are shown in FIG. 3: The UE is registered 301 in LTE (TAC1, LAC1), the UE is at the edge of LAC1 and LAC2. The UE is registered 302 under MSC1, LAC1 and SGs link is transmitted 303 from MME 111 to MSC1 121. The eNodeB 110 transmits (see 304) CS paging message to the UE 101. The UE 101 transmits Extended Service Request message (see 305) to MME 111. The eNodeB 110 transmits (see 306) RRC connection Release message (Redirected to UTRA-UARFCN1) to the UE 101. The UE reselects (see 307) cell in UMTS for UARFCN1. The best cell is found (see 308) in LAC2. The UE transmits an RRC Connection establishment message (see 309) indicating LAC2 to the NodeB 120 and transmits a Location Area Update message (see 310) including CS MT flag set to MSC2 131. MSC2 131 answers the UE 101 with Location Area Update Accept message (see 311). Now, new MSC 131 failed (see 312) to retrieve call context from old MSC 121 and the UE did not receive MT call from the network (see 313).

FIG. 4 is a message sequence chart 400 for a CSFB scenario in the communication system 200 of FIG. 2 for a successful mobile terminating (MT) call according to the disclosure.

The scenario is the following: the UE 101 can detect such use cases where after moving to UMTS/GSM 120, 121 for CSFB call and the best cell available for camping is in different LAC (MSC2, 131) where MT calls are not received. The UE 101 stores the list of {PLMN, LAC} corresponding to the failed MT calls and tries to find out another suitable cell in the same UARFCN1, but in the same LAC for which it was registered in LTE. This will ensure that no call context transfer is required in edge cases and will lead to less latency in MT CSFB calls along with better call success rate.

The following messages and contexts are shown in FIG. 4 to illustrate this scenario: the UE is registered (see 301) in LTE (TAC1, LAC1), the UE is at the edge of LAC1 and LAC2. The UE is registered (see 302) under MSC1, LAC1 and SGs link is transmitted (see 303) from MME 111 to MSC1 121. On receiving MT voice call request, MSC initiates paging towards MME 111 and thus the eNodeB 110 transmits (see 304) CS paging message to the UE 101. The UE 101 transmits Extended Service Request message (see 305) to MME 111. The eNodeB 110 transmits (see 306) RRC connection Release message (Redirected to UTRA-UARFCN1) to the UE 101. The UE reselects (see 307) cell in UMTS for UARFCN1.

The above-described messaging corresponds to the messaging described for the scenario of failed MT CSFB call shown in FIG. 3. The following messaging is different to the scenario of FIG. 3: When the best cell is found in LAC2, the UE searches (see 408) for more cells in registered LAC1. The UE 101 camps (see 409) on cell in registered LAC, i.e. LAC1. The UE 101 transmits an RRC Connection establishment message (see 410) indicating LAC1 to NodeB 120 and transmits a Paging Response message (see 411) to MSC1 121. MSC1 121 answers the UE 101 with Call Setup message (see 412). MSC2 does not come into picture and no LAU is needed as the UE 101 is camped back to registered LAC only (see 413).

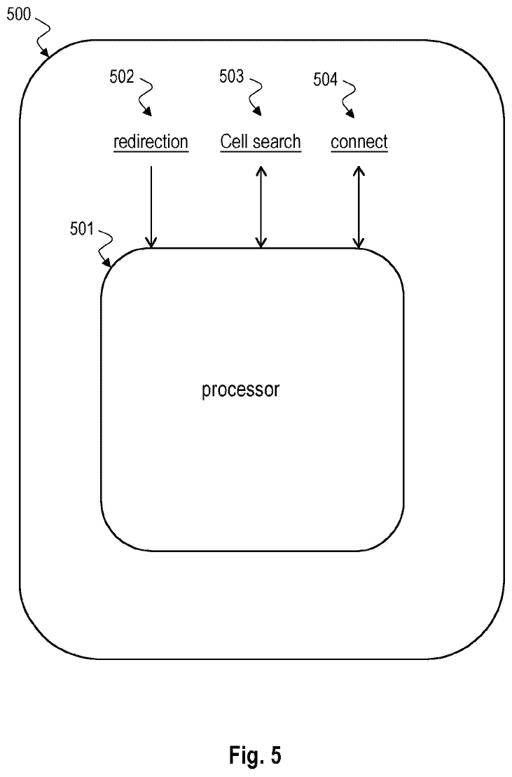

FIG. 5 is a block diagram 500 of a UE circuitry 500 according to the disclosure. The UE circuitry 500 may be included in a UE 101 as described above with respect to FIGS. 1 to 4. In the following a UE circuitry 500 is described that is designed to implement the CSFB scenario for a successful mobile terminating (MT) call as described above with respect to FIG. 4 in a generalized version. This means that the UE circuitry 500 can implement, besides successful return from CSFB calls, also successful transitions and/or returns from any first radio network (e.g. any first RAT network) to any second radio network (e.g. any second RAT network) beyond the context of CSFB calls.

The UE circuitry 500 includes a processor 501. The processor 501 is configured to receive a message indicating a redirection (see 502) from a first radio network to a second radio network while the UE is registered in the first radio network under a first location area code (LAC). The processor 501 is further configured to initiate a cell search (see 503) for radio cells of the second radio network, wherein a specific LAC is assigned to each radio cell of the second radio network. The processor 501 is further configured to connect (see 504) to a first radio cell found by the cell search based on a comparison of a LAC of the first radio cell and the first LAC under which the UE is registered in the first radio network. The processor 501 may be a baseband processor processing signals in baseband. The UE circuitry 500 may further include a transceiver for receiving the redirection message 502, transceiving corresponding messages for cell search 503, and transceiving corresponding messages for the connecting 504. The UE circuitry 500 may be implemented in a UE, e.g. a UE 101 as described above with respect to FIGS. 1 to 4.

The redirection (see 502) may be a CSFB 102 as described above with respect to FIGS. 1 to 4. The first radio network may include radio cell 110 and network entity 111 as described above with respect to FIGS. 1 to 4. The second radio network may include radio cell 120 and network entity 121 as described above with respect to FIGS. 1 to 4. The first location area code may correspond to LAC1 of area 210 as described above with respect to FIG. 2. The second radio network may include radio cell 120 in area 210 with location area code LAC1 and radio cell 130 in area 220 with location area code LAC2 as shown in FIG. 2.

The processor 501 may be configured to connect (see 504) to the first radio cell if the LAC of the first radio cell corresponds to the first LAC under which the UE 101 is registered in the first radio network.

The first radio network may include a radio network according to a first Radio Access Technology (RAT). The second radio network may include a radio network according to a second RAT.

The second radio network may include a Circuit Switch (CS) network. The first radio network may include a Packet Switch (PS) network.

The redirection message (see 502) may indicate a Circuit Switch FallBack (CSFB) call, e.g. as described in the scenarios of FIGS. 1 to 4. In particular, the redirection message (see 502) may indicate a mobile terminating (MT) call.

The processor 501 may be configured to connect (see 504) to the first radio cell even if another radio cell having a higher quality than the first radio cell is found by the cell search (see 503) under a different LAC than the first LAC. For example, if a radio signal received from the other radio cell has a better quality than a radio signal received from the first radio cell. A received signal strength indicator (RSSI) or a signal power may e.g. be higher for the other radio cell than for the first radio cell. Radio signals received from both or more radio cells may be compared by threshold detection.

The processor 501 may continue performing the cell search (see 503) if only radio cells under a different LAC than the first LAC are found by the cell search (see 503). For example, a stop criterion may be implemented for realizing the cell search (see 503). The stop criterion may be based on number of cells found or on signal thresholds of found radio cells.

The processor 501 may connect (see 504) the UE to the first radio cell of the second radio network by transmitting a Radio Resource Control (RRC) Connection Establishment message under the first LAC to the second radio network, e.g. a message (see 410) as described above with respect to FIG. 4.

The processor 501 may respond to a paging from the first radio cell of the second radio network, e.g. by transmitting a Paging Response (see 411) as shown in FIG. 4.

The message indicating the redirection from the first radio network to the second radio network may include an RRC Connection Release message, e.g. a message (see 306) as shown in FIG. 4. The RRC Connection Release message may indicate specific resources of the second radio network, e.g. an UTRA absolute radio frequency channel number UARFCN1 as shown in FIG. 4.

The processor 501 may initiate the cell search (see 503) for radio cells of the second radio network using the specific resources of the second radio network. These specific resources of the second radio network may include a specific radio frequency channel number, e.g. the above mentioned UARFCN1. The processor 501 may initiate the cell search (see 503) for radio cells of the second radio network at the specific radio frequency channel number.

The processor 501 may store a list of radio cells of the second radio network with corresponding LACs as found by the cell search (see 503). The processor 501 may select a radio cell from the list. The LAC of the selected radio cell may correspond to the first LAC. The selection may be based on a quality of the radio cell. In particular, the quality of the selected radio cell may be higher than qualities of other radio cells from the list, wherein the LACs of the other radio cells correspond to the first LAC.

A radio cell having a higher quality may provide a better call success rate and lower latency compared to a radio cell having a lower quality, thus resulting in a better quality of experience for the user.

The UE 101 may be located at an edge of the first radio cell of the second radio network and a second radio cell of the second radio network, e.g. according to the scenario shown in FIG. 2, wherein a LAC of the second radio cell is different from the LAC of the first radio cell. In such a scenario, the first radio cell and the second radio cell of the second radio network may serve the UE without forwarding call contexts to the other radio cell. The first radio cell and the second radio cell of the second radio network may serve the UE without exchanging their LACs during call establishment or call redirection, e.g. according to the scenarios described above with respect to FIGS. 1 to 4.

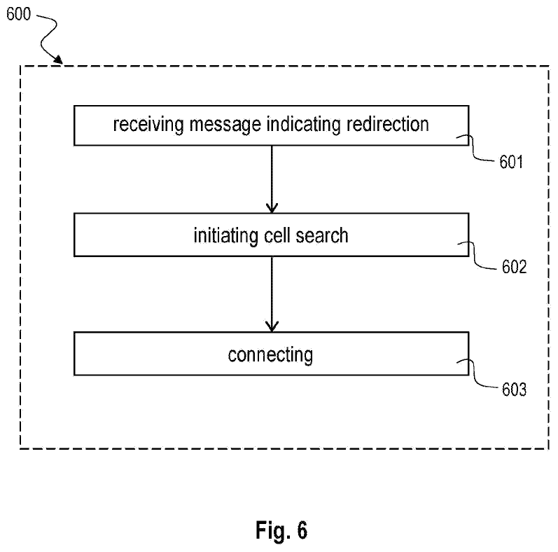

FIG. 6 is a schematic diagram of a method 600 for redirection from a first radio network to a second radio network according to the disclosure. The method 600 may be implemented in a UE circuitry 500 as described above with respect to FIG. 5 or in a UE 101 as described above with respect to FIGS. 1 to 4.

In the following a method 600 is described that is designed to implement the CSFB scenario for a successful mobile terminating (MT) call as described above with respect to FIG. 4 in a generalized version. This means that the method 600 can implement, besides successful return from CSFB calls, also successful transitions and/or returns from any first radio network (e.g. any first RAT network) to any second radio network (e.g. any second RAT network) beyond the context of CSFB calls.

The method 600 includes receiving (see 601) a message indicating a redirection from a first radio network to a second radio network during a registration of a user equipment (UE) in the first radio network under a first location area code (LAC). The method 600 further includes initiating (see 602) a cell search for radio cells of the second radio network, wherein a specific LAC is assigned to each radio cell of the second radio network. The method 600 further includes connecting (see 603) to a first radio cell found by the cell search based on a comparison of a LAC of the first radio cell and the first LAC under which the UE is registered in the first radio network.

The redirection message may be a CSFB 102 as described above with respect to FIGS. 1 to 4. The first radio network may include radio cell 110 and network entity 111 as described above with respect to FIGS. 1 to 5. The second radio network may include radio cell 120 and network entity 121 as described above with respect to FIGS. 1 to 4. The first location area code may correspond to LAC1 of area 210 as described above with respect to FIG. 2. The second radio network may include radio cell 120 in area 210 with location area code LAC1 and radio cell 130 in area 220 with location area code LAC2 as shown in FIG. 2.

The method 600 may further include connecting to the first radio cell if the LAC of the first radio cell corresponds to the first LAC under which the UE is registered in the first radio network.

The first radio network may include a radio network according to a first Radio Access Technology (RAT). The second radio network may include a radio network according to a second RAT. The second radio network may include a Circuit Switch (CS) network. The first radio network may include a Packet Switch (PS) network. The redirection message may indicate a Circuit Switch FallBack (CSFB) call. The redirection message may indicate a mobile terminating (MT) call.

The method 600 may further include connecting to the first radio cell even if another radio cell having a higher quality than the first radio cell is found by the cell search under a different LAC than the first LAC.

The method 600 may further include: continuing with the cell search if only radio cells under a different LAC than the first LAC are found by the cell search.

Connecting to the first radio cell of the second radio network may include transmitting a Radio Resource Control (RRC) Connection Establishment under the first LAC to the second radio network, e.g. as described in FIGS. 4 and 5. The method 600 may further include responding to a paging from the first radio cell of the second radio network, e. g. as described above with respect to FIGS. 4 and 5.

The message indicating the redirection from the first radio network to the second radio network may include an RRC Connection Release message, e.g. as described above with respect to FIGS. 4 and 5. The RRC Connection Release message may indicate specific resources of the second radio network. The method 600 may further include: initiating the cell search for radio cells of the second radio network using the specific resources of the second radio network. The specific resources of the second radio network may include a specific radio frequency channel number, e.g. as described above with respect to FIGS. 4 and 5.

The method 600 may further include initiating the cell search for radio cells of the second radio network at the specific radio frequency channel number. The method 600 may further include storing a list of radio cells of the second radio network with corresponding LACs as found by the cell search in the UE.

The method 600 may further include selecting a radio cell from the list, wherein the LAC of the selected radio cell corresponds to the first LAC, wherein the selection is based on a quality of the radio cell. The quality of the selected radio cell may be higher than qualities of other radio cells from the list, wherein the LACs of the other radio cells correspond to the first LAC. A radio cell having a higher quality may provide a better call success rate and lower latency compared to a radio cell having a lower quality.

The UE may be located at an edge of the first radio cell of the second radio network and a second radio cell of the second radio network, wherein a LAC of the second radio cell is different from the LAC of the first radio cell. The first radio cell and the second radio cell of the second radio network may be configured to serve the UE without forwarding call contexts to the other radio cell. The first radio cell and the second radio cell of the second radio network may be configured to serve the UE without exchanging their LACs during call establishment or call redirection.

The devices and systems described in this disclosure may be implemented as Digital Signal Processors (DSP), micro-controllers or any other side-processor or hardware circuit on a chip or an application specific integrated circuit (ASIC).

Embodiments described in this disclosure can be implemented in digital electronic circuitry, or in computer hardware, firmware, software, or in combinations thereof, e.g. in available hardware of mobile devices or in new hardware dedicated for processing the methods described herein.

The present disclosure also supports a computer program product including computer executable code or computer executable instructions that, when executed, causes at least one computer to execute the performing and computing blocks described herein, in particular the message sequence charts 300, 400 and the method 600 described above with respect to FIGS. 3, 4 and 6 as well as the computing and/or network blocks described above with respect to FIGS. 2 and 5. Such a computer program product may include a non-transient readable storage medium storing program code thereon for use by a processor, the program code comprising instructions for performing the methods or the computing blocks as described above.

### EXAMPLES

The following examples pertain to further embodiments. Example 1 is a user equipment (UE) circuitry comprising a processor, wherein the processor is configured to: receive a message indicating a redirection from a first radio network to a second radio network while the UE is registered in the first radio network under a first location area code (LAC); initiate a cell search for radio cells of the second radio network, wherein a specific LAC is assigned to at least one, in particular each, radio cell of the second radio network; and connect to a first radio cell found by the cell search based on a comparison of a LAC of the first radio cell and the first LAC under which the UE is registered in the first radio network.

In Example 2, the subject matter of Example 1 can optionally include that the processor is configured to connect to the first radio cell if the LAC of the first radio cell corresponds to the first LAC under which the UE is registered in the first radio network.

In Example 3, the subject matter of any one of Examples 1-2 can optionally include that the first radio network comprises a radio network according to a first Radio Access Technology (RAT); and that the second radio network comprises a radio network according to a second RAT.

In Example 4, the subject matter of any one of Examples 1-2 can optionally include that the second radio network comprises a Circuit Switch (CS) network; and that the first radio network comprises a Packet Switch (PS) network.

In Example 5, the subject matter of any one of Examples 1-4 can optionally include that the message indicates a Circuit Switch FallBack (CSFB) call.

In Example 6, the subject matter of any one of Examples 1-5 can optionally include that the message indicates a mobile terminating (MT) call.

In Example 7, the subject matter of any one of Examples 1-6 can optionally include that the processor is configured to connect to the first radio cell even if another radio cell having a higher quality than the first radio cell is found by the cell search under a different LAC than the first LAC where UE detects user moving from first LAC to that particular different LAC during MT CSFB faces call failure.

In Example 8, the subject matter of any one of Examples 1-7 can optionally include that the processor is configured to continue performing the cell search if radio cells under a different LAC than the first LAC are found by the cell search, in particular if only radio cells under a different LAC than the first LAC are found by the cell search.

In Example 9, the subject matter of any one of Examples 1-8 can optionally include that the processor is configured to connect to the first radio cell of the second radio network by transmitting a Radio Resource Control (RRC) Connection Establishment under the first LAC to the second radio network.

In Example 10, the subject matter of Example 9 can optionally include that the processor is configured to respond to a paging message from the first radio cell of the second radio network.

In Example 11, the subject matter of any one of Examples 1-10 can optionally include that the message indicating the redirection from the first radio network to the second radio network comprises an RRC Connection Release message.

In Example 12, the subject matter of Example 11 can optionally include that the RRC Connection Release message indicates specific resources of the second radio network.

In Example 13, the subject matter of Example 12 can optionally include that the processor is configured to initiate the cell search for radio cells of the second radio network using the specific resources of the second radio network.

In Example 14, the subject matter of any one of Examples 12-13 can optionally include that the specific resources of the second radio network comprise a specific radio frequency channel number.

In Example 15, the subject matter of Example 14 can optionally include that the processor is configured to initiate the cell search for radio cells of the second radio network at the specific radio frequency channel number.

In Example 16, the subject matter of any one of Examples 1-15 can optionally include that the processor is configured to store a list of radio cells of the second radio network with corresponding LACs as found by the cell search.

In Example 17, the subject matter of Example 16 can optionally include that the processor is configured to select a radio cell from the list, wherein the LAC of the selected radio cell corresponds to the first LAC, wherein the selection is based on a quality of the radio cell.

In Example 18, the subject matter of Example 17 can optionally include that the quality of the selected radio cell is higher than qualities of other radio cells from the list, wherein the LACs of the other radio cells correspond to the first LAC.

In Example 19, the subject matter of any one of Examples 1-18 can optionally include that a radio cell having a higher quality provides a better call success rate and lower latency compared to a radio cell having a lower quality.

In Example 20, the subject matter of any one of Examples 19 can optionally include that the UE is located at an edge of the first radio cell of the second radio network and a second radio cell of the second radio network, wherein a LAC of the second radio cell is different from the LAC of the first radio cell.

In Example 21, the subject matter of Example 20 can optionally include that the first radio cell and the second radio cell of the second radio network are configured to serve the UE without forwarding call contexts to the other radio cell.

In Example 22, the subject matter of any one of Examples 20-21 can optionally include that the first radio cell and the second radio cell of the second radio network are configured to serve the UE without exchanging their LACs during call establishment or call redirection.

Example 23 is a method for redirection from a first radio network to a second radio network, the method comprising: receiving a message indicating a redirection from a first radio network to a second radio network during a registration of a user equipment (UE) in the first radio network under a first location area code (LAC); initiating a cell search for radio cells of the second radio network, wherein a specific LAC is assigned to at least one radio cell, in particular each radio cell, of the second radio network; and connecting to a first radio cell found by the cell search based on a comparison of a LAC of the first radio cell and the first LAC under which the UE is registered in the first radio network.

In Example 24, the subject matter of Example 23 can optionally include: connecting to the first radio cell if the LAC of the first radio cell corresponds to the first LAC under which the UE is registered in the first radio network.

In Example 25, the subject matter of any one of Examples 23-24 can optionally include that the first radio network comprises a radio network according to a first Radio Access Technology (RAT); and that the second radio network comprises a radio network according to a second RAT.

In Example 26, the subject matter of any one of Examples 23-24 can optionally include that the second radio network comprises a Circuit Switch (CS) network; and that the first radio network comprises a Packet Switch (PS) network.

In Example 27, the subject matter of any one of Examples 23-26 can optionally include that the message indicates a Circuit Switch FallBack (CSFB) call.

In Example 28, the subject matter of any one of Examples 23-27 can optionally include that the message indicates a mobile terminating (MT) call.

In Example 29, the subject matter of any one of Examples 23-28 can optionally include: connecting to the first radio cell even if another radio cell having a higher quality than the first radio cell is found by the cell search under a different LAC than the first LAC where UE detects user moving from first LAC to that particular different LAC during MT CSFB faces call failure.

In Example 30, the subject matter of any one of Examples 23-29 can optionally include: continuing with the cell search if radio cells under a different LAC than the first LAC are found by the cell search, in particular if only radio cells under a different LAC than the first LAC are found by the cell search.

In Example 31, the subject matter of any one of Examples 23-30 can optionally include that connecting to the first radio cell of the second radio network comprises transmitting a Radio Resource Control (RRC) Connection Establishment under the first LAC to the second radio network.

In Example 32, the subject matter of Example 31 can optionally include: responding to a paging message from the first radio cell of the second radio network.

In Example 33, the subject matter of any one of Examples 23-32 can optionally include that the message indicating the redirection from the first radio network to the second radio network comprises an RRC Connection Release message.

In Example 34, the subject matter of Example 33 can optionally include that the RRC Connection Release message indicates specific resources of the second radio network.

In Example 35, the subject matter of Example 34 can optionally include: initiating the cell search for radio cells of the second radio network using the specific resources of the second radio network.

In Example 36, the subject matter of any one of Examples 34-35 can optionally include that the specific resources of the second radio network comprise a specific radio frequency channel number.

In Example 37, the subject matter of Example 36 can optionally include: initiating the cell search for radio cells of the second radio network at the specific radio frequency channel number.

In Example 38, the subject matter of any one of Examples 23-37 can optionally include: storing a list of radio cells of the second radio network with corresponding LACs as found by the cell search in the UE.

In Example 39, the subject matter of Example 38 can optionally include: selecting a radio cell from the list, wherein the LAC of the selected radio cell corresponds to the first LAC, wherein the selection is based on a quality of the radio cell.

In Example 40, the subject matter of Example 39 can optionally include that the quality of the selected radio cell is higher than qualities of other radio cells from the list, wherein the LACs of the other radio cells correspond to the first LAC.

In Example 41, the subject matter of any one of Examples 23-40 can optionally include that a radio cell having a higher quality provides a better call success rate and lower latency compared to a radio cell having a lower quality.

In Example 42, the subject matter of any one of Examples 23-41 can optionally include that the UE is located at an edge of the first radio cell of the second radio network and a second radio cell of the second radio network, wherein a LAC of the second radio cell is different from the LAC of the first radio cell.

In Example 43, the subject matter of Example 42 can optionally include that the first radio cell and the second radio cell of the second radio network are configured to serve the UE without forwarding call contexts to the other radio cell.

In Example 44, the subject matter of any one of Examples 42-43 can optionally include that the first radio cell and the second radio cell of the second radio network are configured to serve the UE without exchanging their LACs during call establishment or call redirection.

Example 45 is a user equipment (UE), comprising: a receiver configured to receive a mobile terminating (MT) Circuit Switch Fallback (CSFB) call while the UE is registered in a data network under a specific location area code (LAC), wherein the MT CSFB call indicates fallback to a Circuit Switch (CS) network; and a processor configured to: initiate a cell search for radio cells of the CS network; and connect to a radio cell found by the cell search if a LAC assigned to the radio cell corresponds to the specific LAC of the data network in which the UE is registered.

In Example 46, the subject matter of Example 45 can optionally include that the data network comprises a radio network according to a Long Term Evolution (LTE) standard; and that the second radio network comprises a radio network according to a UMTS or GSM standard.

In Example 47, the subject matter of any one of Examples 45-46 can optionally include that the processor is configured to connect to the radio cell even if a second radio cell having a higher quality than the radio cell is found by the cell search under a different LAC than the specific LAC of the data network in which the UE is registered.

In Example 48, the subject matter of any one of Examples 45-47 can optionally include that the receiver is configured to receive an RRC Connection Release message comprising a specific radio frequency channel number.

In Example 49, the subject matter of Example 48 can optionally include that the processor is configured to initiate the cell search for radio cells of the CS network based on the specific radio frequency channel number.

In Example 50, the subject matter of any one of Examples 45-49 can optionally include that the UE is located at an edge of two radio cells of the CS network, wherein the two radio cells comprise different LACs.

In Example 51, the subject matter of Example 50 can optionally include that the two radio cells are configured to serve the UE without forwarding call contexts to the other radio cell.

Example 52 is a device for redirection from a first radio network to a second radio network, the device comprising: means for receiving a message indicating a redirection from a first radio network to a second radio network during a registration of a user equipment (UE) in the first radio network under a first location area code (LAC); means for initiating a cell search for radio cells of the second radio network; and means for connecting to a first radio cell of the second radio network found by the cell search if a LAC of the first radio cell corresponds to the first LAC under which the UE is registered in the first radio network.

In Example 53, the subject matter of Example 52 can optionally include that the first radio network comprises a radio network according to a first Radio Access Technology (RAT); and that the second radio network comprises a radio network according to a second RAT.

Example 54 is a processor system for a user equipment (UE) circuitry, the processor system comprising: a first component configured to receive a message indicating a redirection from a first radio network to a second radio network while the UE is registered in the first radio network under a first location area code (LAC); a second component configured to initiate a cell search for radio cells of the second radio network; and a third component configured to connect to a first radio cell of the second radio network found by the cell search if a LAC of the first radio cell corresponds to the first LAC under which the UE is registered in the first radio network.

In Example 55, the subject matter of Example 54 can optionally include that the second radio network comprises a Circuit Switch (CS) network; and that the first radio network comprises a Packet Switch (PS) network.

Example 56 is a computer readable non-transitory medium on which computer instructions are stored which when executed by a computer cause the computer to perform the method of any one of Examples 23 to 44.

In addition, while a particular feature or aspect of the disclosure may have been disclosed with respect to only one of several implementations, such feature or aspect may be combined with one or more other features or aspects of the other implementations as may be desired and advantageous for any given or particular application. Furthermore, to the extent that the terms “include”, “have”, “with”, or other variants thereof are used in either the detailed description or the claims, such terms are intended to be inclusive in a manner similar to the term “comprise”. Furthermore, it is understood that aspects of the disclosure may be implemented in discrete circuits, partially integrated circuits or fully integrated circuits or programming means. Also, the terms “exemplary”, “for example” and “e.g.” are merely meant as an example, rather than the best or optimal.

Although specific aspects have been illustrated and described herein, it will be appreciated by those of ordinary skill in the art that a variety of alternate and/or equivalent implementations may be substituted for the specific aspects shown and described without departing from the scope of the present disclosure. This application is intended to cover any adaptations or variations of the specific aspects discussed herein.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

1-25. (canceled)

26. A user equipment (UE) circuitry comprising a processor,
wherein the processor is configured to:
receive a message indicating a redirection from a first radio network to a second radio network while the UE is registered in the first radio network under a first location area code (LAC);
initiate a cell search for radio cells of the second radio network, wherein a specific LAC is assigned to at least one radio cell of the second radio network; and
connect to a first radio cell found by the cell search based on a comparison of a LAC of the first radio cell and the first LAC under which the UE is registered in the first radio network.

27. The UE circuitry of claim 26,
wherein the processor is configured to connect to the first radio cell if the LAC of the first radio cell corresponds to the first LAC under which the UE is registered in the first radio network.

28. The UE circuitry of claim 26,
wherein the first radio network comprises a radio network according to a first Radio Access Technology (RAT); and
wherein the second radio network comprises a radio network according to a second RAT.

29. The UE circuitry of claim 26,
wherein the second radio network comprises a Circuit Switch (CS) network; and
wherein the first radio network comprises a Packet Switch (PS) network.

30. The UE circuitry of claim 26,
wherein the message indicates a Circuit Switch FallBack (CSFB) call.

31. The UE circuitry of claim 26,
wherein the message indicates a mobile terminating (MT) call.

32. The UE circuitry of claim 26,
wherein the processor is configured to connect to the first radio cell even if another radio cell having a higher quality than the first radio cell is found by the cell search under a different LAC than the first LAC.

33. The UE circuitry of claim 26,
wherein the processor is configured to continue performing the cell search if radio cells under a different LAC than the first LAC are found by the cell search.

34. The UE circuitry of claim 26,
wherein the processor is configured to connect to the first radio cell of the second radio network by transmitting a Radio Resource Control (RRC) Connection Establishment under the first LAC to the second radio network.

35. The UE circuitry of claim 34,
wherein the processor is configured to respond to a paging message from the first radio cell of the second radio network.

36. The UE circuitry of claim 26,
wherein the message indicating the redirection from the first radio network to the second radio network comprises an RRC Connection Release message.

37. The UE circuitry of claim 36,
wherein the RRC Connection Release message indicates specific resources of the second radio network.

38. The UE circuitry of claim 37,
wherein the processor is configured to initiate the cell search for radio cells of the second radio network using the specific resources of the second radio network.

39. The UE circuitry of claim 37,
wherein the specific resources of the second radio network comprise a specific radio frequency channel number.

40. The UE circuitry of claim 39,
wherein the processor is configured to initiate the cell search for radio cells of the second radio network at the specific radio frequency channel number.

41. The UE circuitry of claim 26,
wherein the processor is configured to store a list of radio cells of the second radio network with corresponding LACs as found by the cell search.

42. A method for redirection from a first radio network to a second radio network, the method comprising:
receiving a message indicating a redirection from a first radio network to a second radio network during a registration of a user equipment (UE) in the first radio network under a first location area code (LAC);
initiating a cell search for radio cells of the second radio network, wherein a specific LAC is assigned to at least one radio cell of the second radio network; and
connecting to a first radio cell found by the cell search based on a comparison of a LAC of the first radio cell and the first LAC under which the UE is registered in the first radio network.

43. The method of claim 42, comprising:
connecting to the first radio cell if the LAC of the first radio cell corresponds to the first LAC under which the UE is registered in the first radio network.

44. A user equipment (UE), comprising:
a receiver configured to receive a mobile terminating (MT) Circuit Switch Fallback (CSFB) call while the UE is registered in a data network under a specific location area code (LAC), wherein the MT CSFB call indicates fallback to a Circuit Switch (CS) network; and
a processor configured to:
initiate a cell search for radio cells of the CS network; and connect to a radio cell found by the cell search if a LAC assigned to the radio cell corresponds to the specific LAC of the data network in which the UE is registered.

45. The UE of claim 44,
wherein the data network comprises a radio network according to a Long Term Evolution (LTE) standard; and
wherein the second radio network comprises a radio network according to a UMTS or GSM standard.

46. A device for redirection from a first radio network to a second radio network, the device comprising:
means for receiving a message indicating a redirection from a first radio network to a second radio network during a registration of a user equipment (UE) in the first radio network under a first location area code (LAC);
means for initiating a cell search for radio cells of the second radio network; and
means for connecting to a first radio cell of the second radio network found by the cell search if a LAC of the first radio cell corresponds to the first LAC under which the UE is registered in the first radio network.

47. The device of claim 46,
wherein the first radio network comprises a radio network according to a first Radio Access Technology (RAT); and
wherein the second radio network comprises a radio network according to a second RAT.

48. A processor system for a user equipment (UE) circuitry, the processor system comprising:
a first component configured to receive a message indicating a redirection from a first radio network to a second radio network while the UE is registered in the first radio network under a first location area code (LAC);
a second component configured to initiate a cell search for radio cells of the second radio network; and
a third component configured to connect to a first radio cell of the second radio network found by the cell search if a LAC of the first radio cell corresponds to the first LAC under which the UE is registered in the first radio network.

49. The processor system of claim 48,
wherein the second radio network comprises a Circuit Switch (CS) network; and
wherein the first radio network comprises a Packet Switch (PS) network.
